(19) United States
(12) Patent Application Publication
(10) Pub. No.: US 2007/0285808 A1
(43) Pub. Date: Dec. 13, 2007

(54) Mirror system for a trucking rig having a tractor and an articulated trailer

(76) Inventor: Harry A. Beale, Charlotte, NC (US)

Correspondence Address: KRATZ, QUINTOS & HANSON, LLP, 1420 K Street, N.W., Suite 400, WASHINGTON, DC, 20005, US

(21) Appl. No.: 11/819,209

(22) Filed: Jun. 26, 2007

Related U.S. Application Data
(63) Continuation-in-part of application No. 11/451,952, filed on Jun. 13, 2006.

(51) Int. Cl. B60R 1/07

(52) U.S. Cl. 359/843; 359/862

(57) ABSTRACT

A mirror system for a tractor with an articulated trailer includes a mirror housing. The mirror housing is attached to the front end of the tractor on the passenger side. The mirror housing has a planar mirror. The planar mirror is adapted to move. The planar mirror moves allowing continuous observation of the passenger side rear corner of the trailer by a driver.

This application is a Continuation-in-Part application of U.S. application Ser. No. 11/451,952, filed Jun. 13, 2006, the contents of which are incorporated herein by reference.

### FIELD OF INVENTION

The instant application relates to a mirror system for a trucking rig having a tractor and an articulated trailer.

### BACKGROUND OF THE INVENTION

Trucking rigs having a tractor and an articulated trailer present many obstacles when it comes to the vision of the driver or what the driver can see while driving. Trucking rigs having a trailer cannot use the usual automobile-rearview mirror (mounted on the inside of the windshield) because all the driver would see is the sleeper berth or the front of the trailer. To compensate for the lack of rearview mirrors, each tractor is outfitted with an assortment of side-view mirrors. These side-view mirrors aid the drivers in seeing what is behind and beside them.

Side-view mirrors on a trucking rig with a tractor and an articulated trailer are located on the passenger and driver sides of the tractor to view line-of-sight down the passenger and driver sides of the trailer to the respective rear corner of the trailer. Large rectangular planar mirrors, or flat mirrors, are fastened to the doors on both sides of the tractor. These door-mounted mirrors are the subject of known relevant prior art. U.S. Pat. No. 3,640,608 to McKee et al. discloses the mirror of interest as being mounted on the door of the tractor. U.S. Pat. No. 6,151,175 to Osha; U.S. Pat. No. 6,264,337 to Rannells et al.; and U.S. Pat. No. 6,390,631 Lang et al., display and define the door-mounted planar mirror. A cabover tractor has a flat nose with the cab being mounted directly above the engine. The other principal design of tractors is called conventional and has the engine mounted in front of the cab. These tractors typically have a longer wheelbase than cabover tractors. U.S. Pat. No. 5,719,713 to Brown, shows the planar mirror as being mounted on the door of a conventional tractor.

Because these mirrors are planar, they provide an accurate view of how close or how far away things are to the trucking rig, but they have a restricted field of view. To increase the field of view, one or more convex mirrors are attached to the tractor. These mirrors are excellent for informing the driver of potential problems because they have a widened field of view, but are very inexact because they distort distances. Thus, convex mirrors should not generally be used to determine how close or how far away something is to the trucking rig. On cabover tractors, the additional convex mirrors are typically mounted on the bracket frames which holds the planar mirrors. On conventional tractors, the convex mirrors can be mounted similarly to that on the cabover or can also be attached to the hood of the tractor (hood-mount) or the front fender (tripod-mount) of the tractor. When so mounted, the convex mirrors are mounted toward the front, as far as possible, of the tractor while still maintaining mechanical stability.

A critical use of side-view mirrors on a trucking rig occurs when the trucking rig is being backed into a position, a special case of what is often referred to as slow maneuvers. When a driver needs to back the trailer into a position (for loading, parking, etc) the driver maintaining a line-of-sight to the appropriate rear corner of the trailer is very important, for safety concerns. It is also very important that the driver has an accurate view of distance to the rear of the trailer to show the driver how close or how far things are to the back of the trailer. Thus, the driver must rely on the planar mirror when backing. Even the size of these planar mirrors, for use on either tractor design, is presently specified by Federal regulation.

When backing, the angle of the tractor to the trailer deviates to allow the trucking rig to maneuver into a position. The angle of the tractor to the trailer can go from straight to slightly past ninety (90) degrees. This deviation in angle causes the line of sight out through either planar mirror on either the driver or passenger side of the trailer to disappear, preventing a driver from viewing the rear corner of the trailer.

If a driver has a choice when backing, the driver will setup the slow maneuver such that the area into which the trailer is to be backed is to the driver side of the tractor. The planar mirror on the driver side will only show the position of the driver side rear corner of the trailer for a limited time, as the angle between the tractor and the trailer approaches some 25 degrees on the driver side, the rear corner of the trailer is no longer visible in the fixed mirror. Thus, the driver loses sight of the driver side rear corner of the trailer. Because the driver initially approached the parking spot on the driver side of the truck, when the driver loses sight of the driver side rear corner of the trailer in the planar mirror, the driver can simply look out the door window and see the driver side rear corner of the trailer.

Sometimes the driver simply cannot setup the slow maneuver on the driver side, and the driver must setup the backing on the passenger side. This setup is not preferred but might occur for many reasons, like the general parking area being too small or building arrangements, etc. When the backing must be done to the passenger side, the maneuver is known as blind-side backing. This maneuver is very dangerous to the equipment in the driver's charge as well as any other equipment the driver must maneuver around, including possible walls of a building. When blind-side backing, the angle between the tractor and the trailer also typically exceeds some 25 degrees during the maneuver, thus, the passenger side rear corner of the trailer disappears from view in the planar mirror on the passenger door.

Because the driver cannot stay seated and belted and easily look out the passenger side door window and see the passenger side rear corner of the trailer, the driver is typically presented with two choices. First, the driver might ask another party to spot for them. Unless the spotter is another driver, this is often very unsatisfactory, because most lay people are unfamiliar with distances required for effecting maneuvers of long trailers. The other choice is for the driver to get out of the truck and walk around to the passenger side and ascertain the situation, several times. Both of these choices result in lost time and added danger in backing the trucking rig.

A known system to partially solve the blind side backing problems involves a simple motorized planar mirror for use on the passenger side door of the tractor. This is an improvement because it allows the driver to adjust the planar mirror to display the changing angles of the trucking rig, without exiting the tractor. However, as the angle between the tractor and trailer approaches 67 degrees, the plane of the mirror is almost parallel to and coplanar with the plane of the driver's torso, forcing the apparent view through the planar mirror to greatly diminish. This is defined as “fore-shortening.” This means the driver can see very little, if anything. Again, the driver must get a spotter or get out of the truck and walk around to the passenger side to ascertain the situation.

U.S. Pat. No. 5,835,291 to Takayama discloses a mechanical device to extend this door-mounted mirror to the side a distance from the tractor, to allow the door-mounted mirror to display the desired field of view during the entire maneuver. Other prior art discloses means to automate the rotation of the door-mounted mirror, though none also include an additional scheme to alleviate the problem of the door-mounted mirror not being capable of showing the rear corner of the trailer during the entire maneuver, as noted by Takayama.

Another problem that drivers face when backing is lack of illumination during the evening or nighttime. Most tractors are equipped with reverse lights at the back of the tractor to illuminate what is behind the tractor, if no trailer is present. These lights are ineffective with respect to revealing any useful information about the trailer. This makes the objects in the passenger side mirrors very difficult to distinguish and makes maneuvering around the objects very dangerous.

Accordingly, there is a need for a mirror system or mirror systems that address(es) all of these problems for cabover and conventional tractors. Snubnose tractors also exist and are considered similar to conventional tractors, with the difference being a shorter hood, shorter wheel-base, and so improved maneuverability.

### SUMMARY OF THE INVENTION

The instant invention is twofold mirror system for a tractor with an articulated trailer. The mirror system includes a mirror housing. The mirror housing is attached to the front end of the tractor, as far forward as possible, on the passenger side. The twofold design supplements the present planar mirror dictated by Federal regulations.

For the conventional tractor, the mirror housing may have a planar mirror. Possible locations for the mirror housing on a conventional tractor could be the hood-mount or tripod-mount positions. The planar mirror is adapted to move in response to a signal under the control of a mirror position controller. The mirror position controller consists of at least one motor and associated electronics and could be mounted in the mirror housing or elsewhere. The planar mirror moves by either moving the housing itself or by moving the mirror within the housing. This allows continuous observation of the passenger side rear corner of the trailer by a driver during an entire slow maneuver. This mirror has a home position. This is to be distinguished from Takayama, which discloses moving the mirror to the side, which is the only direction available on a cabover tractor. Here the mirror is moved forward. Because the present invention is a supplement to the mirror distinguished by the prior art, it can have a home position which can be utilized for other purposes.

For the cabover tractor, the mirror housing may have an elastically deformable mirror. Two motions are necessary; one involves simply adapting the mirror to move, as for the conventional tractor. As noted in the prior art, the position which is as far forward as possible on the cabover tractor will not allow the viewing of the trailer during the entire slow maneuver. The program code controlling the movement of the mirror will also control reversibly deforming the flexible mirror at the appropriate angles, via the use of a second motor in the mirror housing. The planar shape for observation of exact distances may be retained as long as possible. Thereafter, the mirror will be gradually deformed or bowed to be convex in one direction. The rear corner of the trailer will be visible to the driver during the entire slow maneuver. A compromise has been made between viewing exact distances 100% of the time and a less precarious mechanism. The mirror housing on this tractor design could be approximately one inch wider than is used at present. A narrow vertical planar mirror is thereby accommodated. The vertical strip is separately mechanically adjustable to allow the driver of this tractor design to see the same matter as can be seen in the new subject mirror on the conventional thactor, when that mirror is in its home position.

For the mirror system on the cabover tractor, the deformable mirror lens should be easily replaceable, because most known substances which can be used to fabricate the lens are susceptible to scratching. Further, its operation shall be failsafe, i.e., in the event of a failure of some kind, of the system, the mirror must return to the planar shape. Further, the shape change feature shall only be available for slow maneuvers.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 shows an elevated view of a first embodiment of the mirror system of the present invention.

FIG. 2 shows the mirror housing for a conventional cab in the mirror system of the present invention.

FIG. 3 shows a top view of the trucking rig with the mirror system of FIG. 1.

FIG. 4 shows another top view of the trucking rig with the mirror system of FIG. 1.

FIG. 5 shows an elevated view of a variation of the first embodiment of the mirror system of the present invention.

FIG. 6 shows the mirror housing for a cabover design of a second embodiment of the mirror system of the present invention.

FIGS. 7a and 7b are block diagrams showing the signal flow in the first and second embodiments of the present invention, respectively.

FIG. 8 shows the mirror housing for a cabover design of a modification of a second embodiment of the mirror system of the present invention.

### DETAILED DESCRIPTION OF THE EXEMPLARY EMBODIMENTS

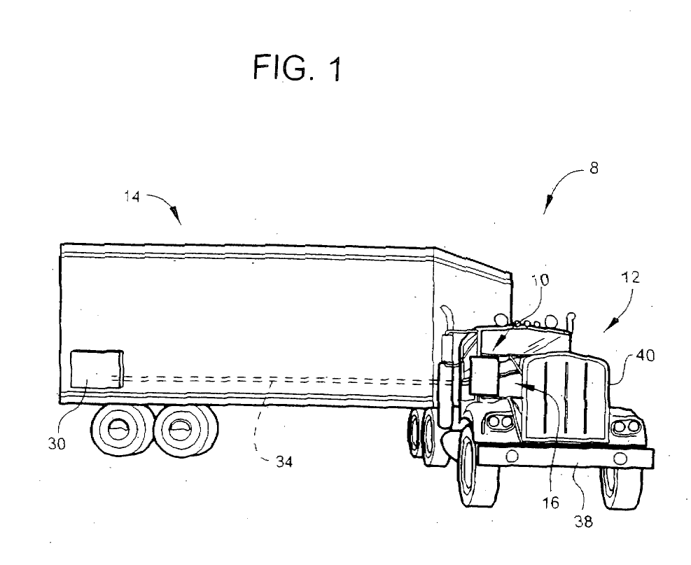

Referring to the drawings, wherein like numerals indicate like elements, there is shown in FIGS. 1 and 3-4 a mirror system 10 for a trucking rig 8 having a tractor 12 and an articulated trailer 14. Mirror system 10 generally comprises a mirror housing 16 and a positioner device 30. Mirror system 10 may allow for observation of the passenger side rear corner of trailer 14 by a driver of tractor 12 while backing in lighted or unlighted conditions.

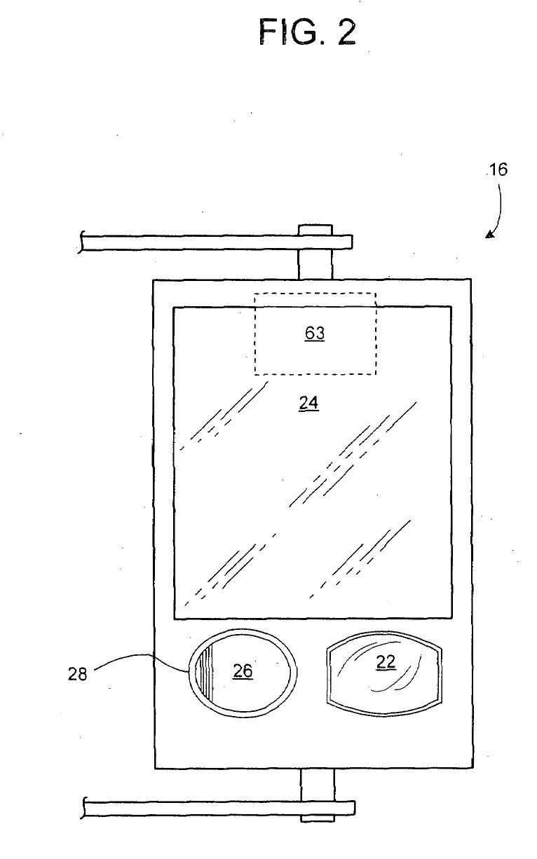

Mirror housing 16 may be attached to the front end of tractor 12 on its passenger side as shown in FIGS. 1 and 3-4. FIG. 1 specifically shows a typical arrangement of the mirror housing 16 on a conventional tractor 12, in addition to the standard door mounted mirror. Mirror housing 16 may have a planar mirror 24. Mirror housing 16 may also include a convex mirror 22, a light source 26, and a baffle 28 as shown in FIG. 2. Mirror housing 16 may be any member capable of holding convex mirror 22, planar mirror 24, light source 26, and baffle 28. Mirror housing 16 may be attached to tractor 12 as far to the front of tractor 12 as possible. Mirror housing 16 may be attached to a front fender 38 of tractor 12 and to the front of a hood 40 of tractor 12, as shown in FIGS. 1 and 3-4. Mirror position controller 62 may move planar mirror 24 and light source 26 via a servo motor 63 contained within mirror housing 16. In the alternative, servo motor 63 could move or rotate the mirror housing 16. Mirror position controller 62 may have a home position that may be automatically selected for positioning planar mirror 24 and light source 26 via servo motor 63 when mirror system 10 is deactivated. Mirror position controller 62 and servo motor 63 may be powered by tractor 12 by connecting a wire to a power source of tractor 12.

Planar mirror 24 may be housed in mirror housing 16, as shown in FIG. 2. Planar mirror 24 may be adapted to move within mirror housing 16 via a mirror position controller 62 and servo motor 63, as shown in FIGS. 2-4 and 6. Planar mirror 24 may allow for viewing the area along the passenger side of trailer 14 all the way to the passenger side rear corner of trailer 14. Planar mirror 24 may move tracking the position of positioner device 30. Planar mirror 24 may provide a reliable view of distance down the passenger side of tractor 12 to the rear corner of trailer 14. Planar mirror 24 may be any type of mirror, including, but not limited to, a flat mirror or a slightly convex mirror.

Convex mirror 22 may be housed in mirror housing 16, as shown in FIG. 2. Convex mirror 22 may be used to warn the driver of danger on the passenger side of trailer 14. Convex mirror 22 may provide a wider angle of view than a flat mirror. Convex mirror 22 may be any convexly shaped mirror. Convex mirror 22 may be a compound convex mirror. A compound convex mirror may be a mirror that is curved in two perpendicular axes that allows for viewing a wider area in the plane defined by the tractor and the trailer.

Light source 26 may be housed in mirror housing 16, as shown in FIG. 2. Light source 26 may be adapted to move within mirror housing 16. Light source 26 may move in order to track the position of positioner device 30 under the control of mirror position controller 62 via servo motor 63. Light source 26 may be used for illuminating the area on the passenger side of tractor 12 all the way to the rear corner of trailer 14. Light source 26 may use any form of light capable of illuminating the area on the passenger side of tractor 12 all the way to the rear of trailer 14.

Baffle 28 may be housed in mirror housing 16, as shown in FIG. 2. Baffle 28 may be used for blocking light source 26 from the view of the driver. Baffle 28 may be any structure capable of blocking light from light source 26 from the view of the driver. Baffle 28 may be a structure built into light source 26, as shown in FIG. 2.

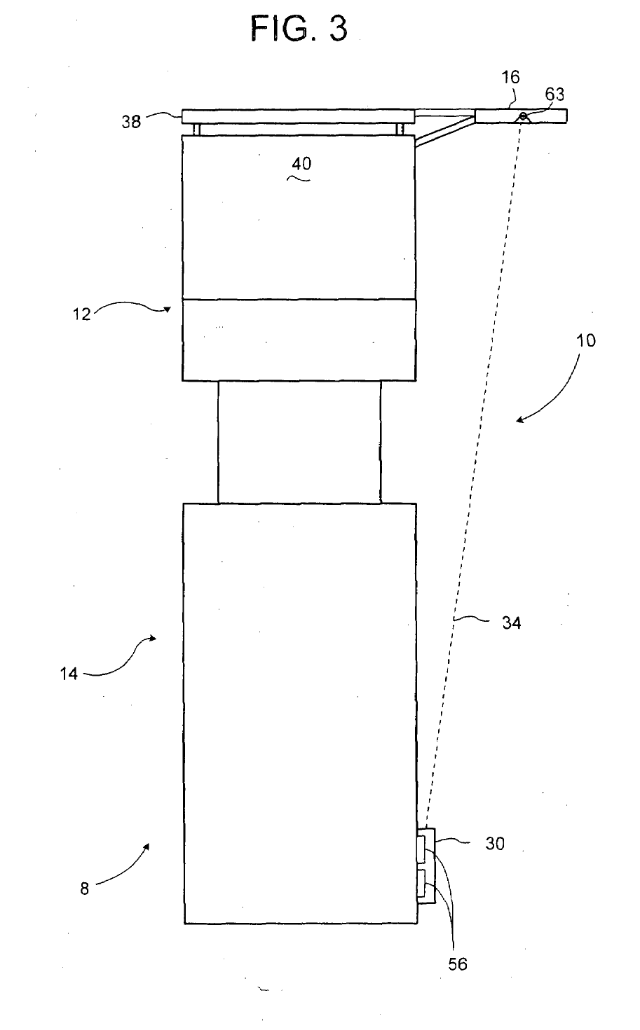

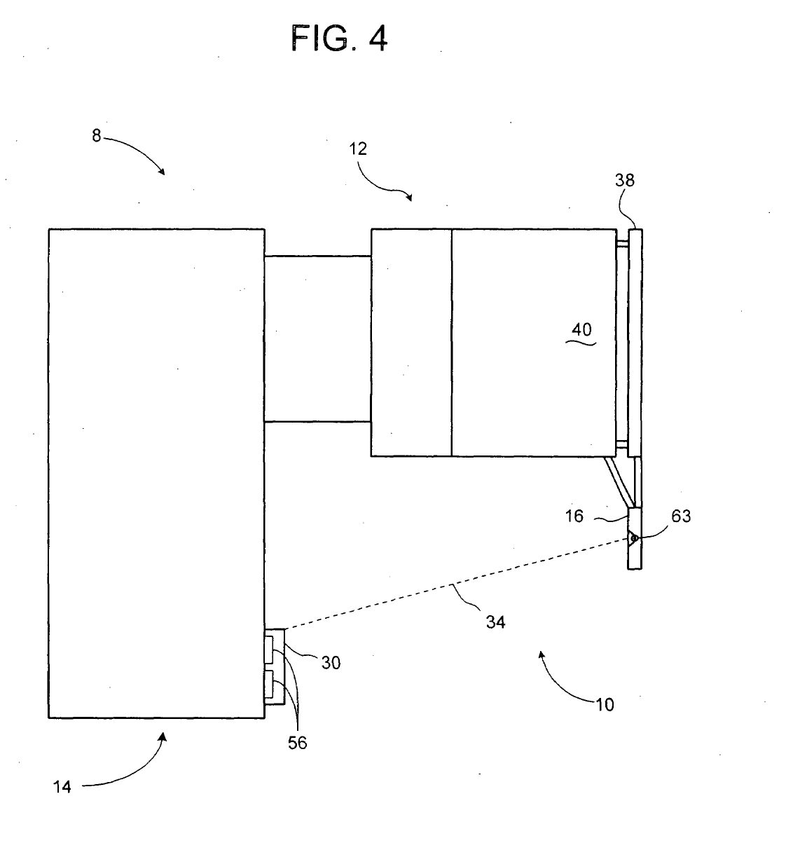

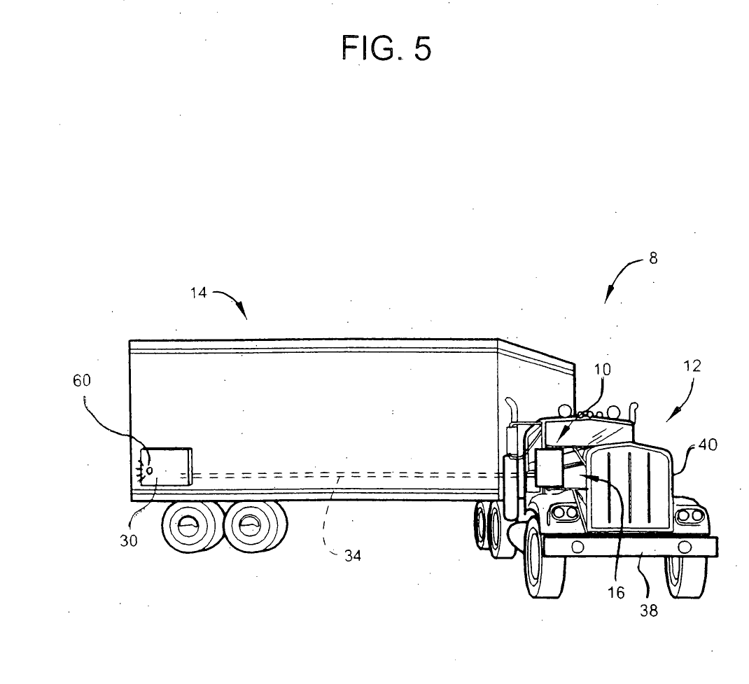

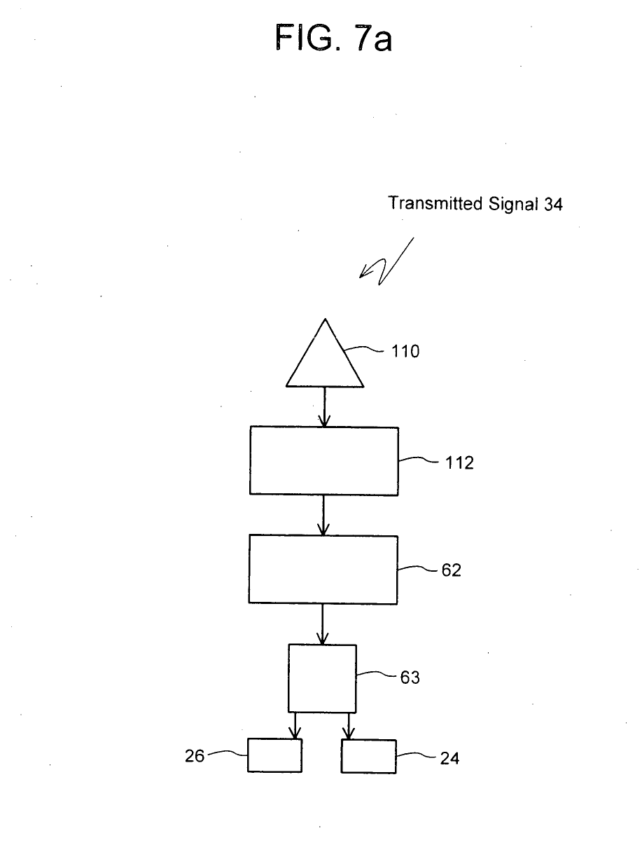

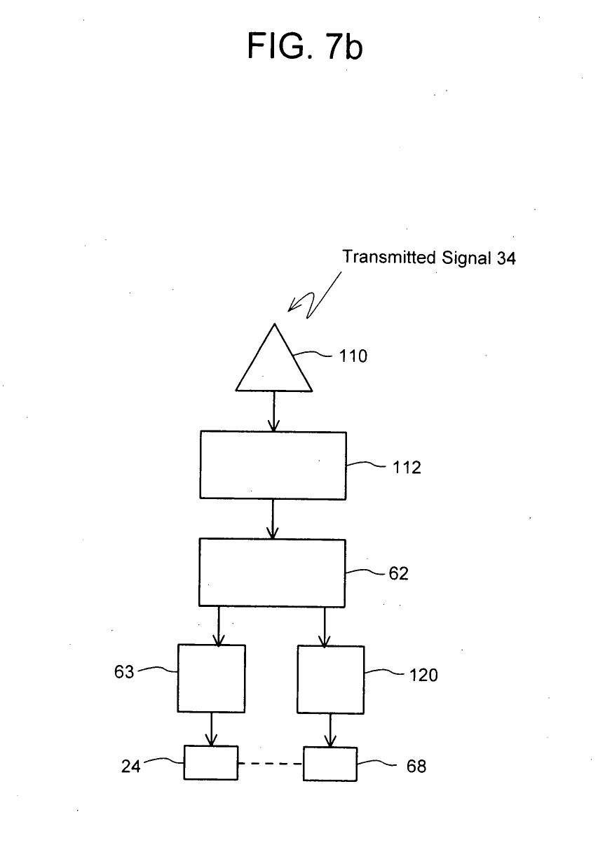

Positioner device 30 may be attached to the rear end of trailer 14 on its passenger side, as shown in FIGS. 1 and 3-4. Positioner device 30 may be used for communicating its position to mirror housing 16. Positioner device 30 may be any device capable of communicating its position to mirror housing 16. Positioner device 30 may be any size. Preferably, positioner device 30 may be as small as possible. In FIGS. 1 and 3-4, positioner device 30 is shown in a large size for illustrative purposes. Positioner device 30 may communicate its position to mirror housing 16 through a transmitted signal 34 to be received by an antenna 110 and receiver 112 located substantially in the mirror housing 16 and connected to mirror position controller 62, as shown in FIGS. 7a and 7b. As shown in FIG. 7a, in the first embodiment, mirror position controller 62 controls servo motor 63 to move both light source 26 and planar mirror 24. Positioner device 30 may position planar mirror 24 and light source 26 based on its position. Positioner device 30 may be attached to trailer 14 by fastener 56, as shown in FIGS. 3-4, or may be permanently attached to trailer 14. Positioner device 30 may be powered by a small battery or may be powered by power from the electrical system of trailer 14. Positioner device 30 might also be self-contained in that one or more rear light sources 60 for illuminating the rear corner of the trailer could be contained therein, as shown in FIG. 5. In this case, servo motor 63 moves only the planar mirror in response to commands from the mirror position controller 62.

Transmitted signal 34 may be a signal transmitted from positioner device 30, as shown in FIGS. 1 and 3-4. Transmitted signal 34 may allow for communication between positioner device 30 and mirror position controller 62. Transmitted signal 34 may be any signal capable of communicating the position of positioner device 30 to mirror position controller 62. Transmitted signal 34 may be a radio frequency with an encryption. The encryption may be any encryption, including, but not limited to a 16 to 128 bit encryption. The radio frequency encryption may allow positioner device 30 to communicate with mirror position controller 62 over a radio frequency that is different from other nearby trucking rigs with mirror system 10. The encryption may reduce the possibility of the radio frequency being confused with another radio frequency.

Fastener 56 may attach positioner device 30 to trailer 14, as shown in FIGS. 3-4. Fastener 56 may be any means of attaching positioner device 30 securely to trailer 14 that allows positioner device 30 to be easily removed.

In operation, when trucking rig 8 is backed into a position on the passenger side of trucking rig 8, the angle of tractor 12 to trailer 14 may approach 90 degrees on the passenger side, as shown in FIG. 4. The position of positioner device 30 may change with respect to mirror housing 16 as the angle of tractor 12 to trailer 14 changes. Because the position of positioner device 30 may change with respect to mirror housing 16, mirror position controller 62 contained in mirror housing 16 may track the position of positioner device 30 through transmitted signal 34. Planar mirror 24 may move in response to signal 34 changing the driver's angle of view through planar mirror 24 to always reflect the position of positioner device 30. Because positioner device 30 maintains its position on the rear passenger side of trailer 14, it allows continuous observation by the driver of the passenger side rear corner of trailer 14 through planar mirror 24 to be maintained while trucking rig 8 is backed into position.

As planar mirror 24 may move, light source 26 may also move in response to transmitted signal 34. Light source 26 may move changing the direction light from light source 26 may be aimed to always aim towards positioner device 30. Because positioner device 30 may be located on the rear passenger side of trailer 14 and light from light source 26 tracks the position of positioner device 30, light source 26 may aim toward the passenger side rear of trailer 14 and may illuminate the area along and beside trailer 14. This may allow continuous illumination of the area along and beside trailer 14 on the passenger side while trucking rig 8 is backed into position. The combination of planar mirror 24 and light source 26 being able to move in response to signal 34 tracking the position of positioner device 30 may allow the driver to maintain a continuous line of sight to the passenger side rear corner of trailer 14 while backing in lighted or unlighted conditions. In the alternative, if a rear light source 60 is included within the positioner device 30, no additional movement of the light is necessary.

When the angle of trailer 14 to tractor 12 approaches 90 degrees on the passenger side, the maximum view through planar mirror 16 may be obtained by positioning mirror housing 16 as far to the front of tractor 12 as possible, as shown in FIGS. 3-4. Mirror housing 16 may be attached to the front fender 38 of tractor 12 and to the front part of hood 40 to be positioned as far to the front of tractor 12 as possible. Positioning mirror housing 16 as far to the front of tractor 12 as possible decreases the angle of reflection from the driver to the mirror and the angle of incidence from the mirror to the rear passenger side of trailer 14 through planar mirror 24. The view through planar mirror 24 of the passenger side rear corner of trailer 14 may decrease, but because mirror housing 16 may be attached as far to the front of tractor 12 as possible, the plane of planar mirror 24 will not approach being coplanar with the plane of the torso of the driver, thereby minimizing fore-shortening effects. By positioning mirror housing 16 as far to the front of tractor 12 as possible, both the angle of reflection through planar mirror 24 from the driver and the angle of incidence through the mirror to the passenger side rear corner of trailer 14 may be as small as possible, thereby allowing the view through planar mirror 24 to be as large as possible.

Because positioner device 30 may be located at different positions relative to mirror housing 16 and planar mirror 24 and light source 26 may still track the position of positioner device 30, mirror system 10 may work with different lengths and sizes of trailers. Thus, when mirror housing 16 may be attached to tractor 12, positioner device 30 may be attached to trailer 14 or any other trailer and mirror system 10 may still function properly. Attaching positioner device 30 by fastener 56 may allow for positioner device 30 to be easily transferred from trailer 14 to another trailer. Positioner device 30 may be powered by a small battery located within positioner device 30. The small battery may eliminate the need to wire positioner device 30 to a power source and may facilitate the transfer of positioner device 30 from trailer 14 to another trailer.

Positioner device 30 may also be permanently attached to trailer 14. Positioner device 30 should be permanently attached to trailer 14 when no trailer other than trailer 14 may be normally used with tractor 12. Positioner device 30 may be powered by tractor 12 by connecting positioner device 30 with the power source of tractor 12. This eliminates the need to change the batteries in positioner device 30.

Mirror system 10 may be in communication with tractor 12. Mirror system 10 may communicate with tractor 12 to determine when mirror system 10 may be activated and deactivated. Mirror system 10 may be activated when the transmission of tractor 12 is in low range and reverse. Mirror system 10 may be deactivated when transmission of tractor 12 is in high range or neutral. When mirror system 10 may be activated, planar mirror 24 and light source 26 may move tracking positioner device 30. When mirror system 10 may be deactivated, planar mirror 24 and light source 26 may move to the home position and be stationary. In another embodiment of the invention mirror system 10 may have a power switch (not shown). The power switch may be used for activating and deactivating mirror system 10. The power switch may be located within tractor 12 allowing the driver to activate and deactivate mirror system 10 while driving.

Mirror system 10 may have a light switch (not shown). The light switch may be for turning light source 26 on and off. The light switch may be located within tractor 12 allowing the driver to turn light source 26 on and off while driving. This may allow the driver the choice of whether he wants light source 26 on or off.

In one embodiment of the invention, convex mirror 22 may be adapted to move. Convex mirror 22 may move to provide the driver a wider angle of view when backing. Convex mirror 22 may be powered to move by the same combination of mirror position controller 62 and servo motor 63 that powers planar mirror 24 and light source 26. Convex mirror 22 may move in response to signal 34 from positioner device 30 allowing the driver a wider view to the passenger side rear corner of trailer 14 by the driver while backing.

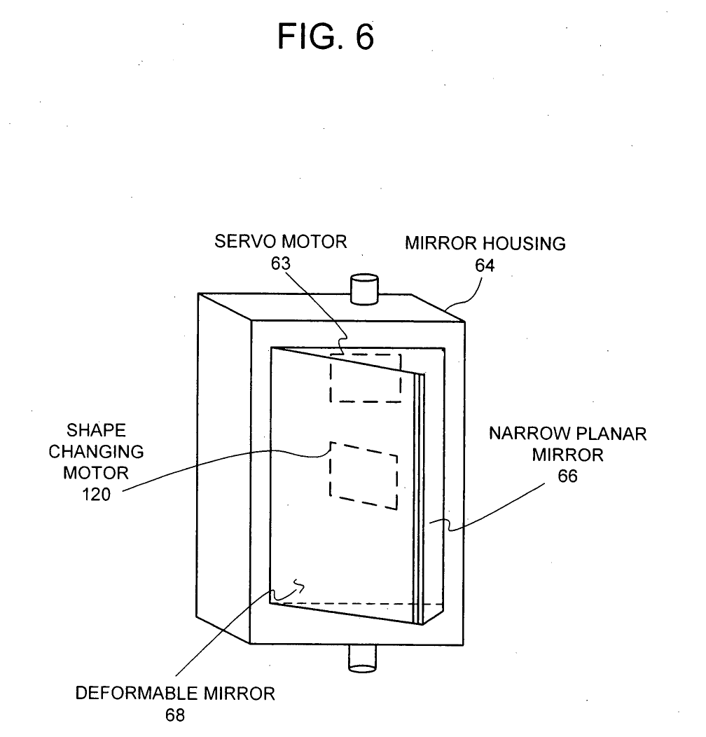

In a second embodiment of the invention, as shown in FIG. 6 for a cabover tractor, mirror housing 64 may contain a small, narrow planar mirror 66 and an elastically deformable mirror 68 adapted to change from a planar shape to a convex shape via a shape changing motor 120. FIG. 7b shows that servo motor 63 moves planar mirror 24 and shape changing motor 120 reshapes deformable mirror 68. Deformable mirror 68 may change to a convex shape for allowing a wider angle of view of the area on the passenger side of tractor 12 to the passenger side rear corner of trailer 14. Providing a wider angle of view of the area on the passenger side of tractor 12 may also allow mirror system 10 to work when longer trailers are connected to conventional tractors. A reshape switch (not shown) may be included to actuate the shape changing motor 120 to reshape deformable mirror 68 to the convex shape and back again. The actual reshaping may be controlled by the mirror position controller 62. The reshape function may permit the driver to choose a planar shape for accurate view of distances or the large convex shape for a wider angle of view when further rotation of the mirror is not useful. This wider angle of view may be useful when longer trailers are connected to a conventional tractor or when present length long trailers are connected to a cabover tractor. The reshape switch may be located within tractor 12.

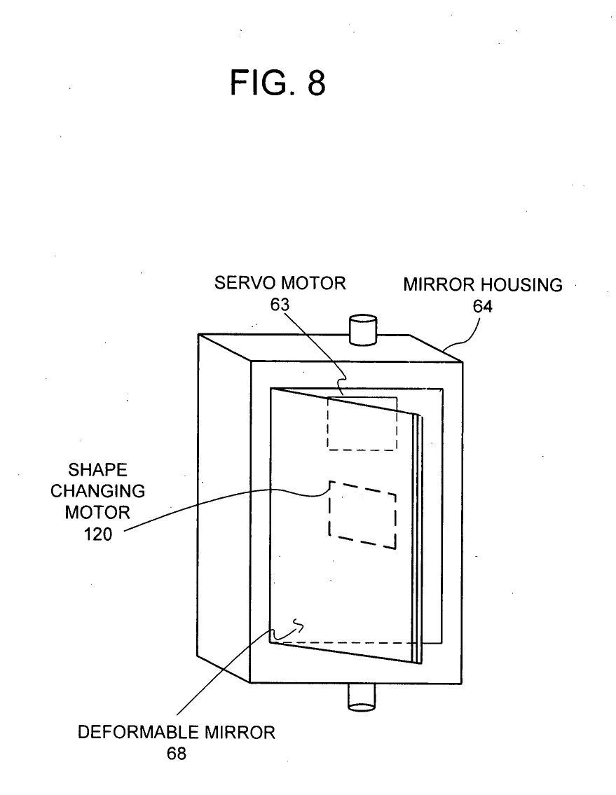

FIG. 8 shows a modification of the second embodiment in which the narrow planar mirror 66 is omitted, thereby leaving elastically deformable mirror 68 as the only mirror in mirror housing 16.

Although mirror system 10 is preferably used on the passenger side of trucking rig 8 because of safety concerns, mirror system 10 may also function on the driver side of trucking rig 8. This is done by mounting mirror housing 16 on the driver side of tractor 12 and attaching positioner device 30 to the driver side rear corner of trailer 14.

The present invention may be embodied in other forms without departing from the spirit and the essential attributes thereof, and, accordingly, reference should be made to the appended claims, rather than to the foregoing specification, as indicated in the scope of the invention.

1. A mirror system for a trucking rig having a tractor and an articulated trailer comprising:
a mirror housing including a mirror movement motor, a planar mirror, and at least one of a convex mirror and a deformable mirror which can be controllably deformed between a planar shape and a convex shape; and
a mirror position controller for controlling said mirror movement motor to change the position of at least one of said mirrrors,
wherein said mirror housing is attached as far to the front of the tractor as possible, and
wherein the controlled movement of at least one of said mirrors allows continuous observation of a rear corner of the trailer.

2. The mirror system of claim 1, wherein said mirror housing is attached to a front fender of said tractor.

3. The mirror system of claim 1, wherein said mirror housing is attached to a front of a hood of said tractor.

4. The mirror system of claim 1, wherein said mirror movement motor is powered by said tractor.

5. The mirror system of claim 1, wherein said mirror housing further comprises a light source moveably controlled by said mirror position controller via said movement motor, and
wherein controlled movement of said at least one movable mirror and said movable light source allows continuous observation of the passenger side rear corner of the trailer in lighted or unlighted conditions.

6. The mirror system of claim 5, wherein said mirror housing further comprises a baffle which continuously blocks said light source from the vision of the driver.

7. The mirror system of claim 5, further comprising a positioner device located at a rear end of the trailer,
wherein said positioner device communicates with an antenna and a receiver connected to said mirror positioning controller via a transmitted signal, and
wherein positions of said at least one movable mirror and said movable light source are automatically adjusted by said mirror position controller via said mirror movement motor in response to said transmitted signal to track movement of a rear corner of the trailer and to allow continuous observation of the rear corner of the trailer by a driver in either lighted or unlighted conditions.

8. The mirror system of claim 7, wherein said positioner device is removably attached to the trailer.

9. The mirror system of claim 7, wherein said positioner device is powered by the tractor.

10. The mirror system of claim 1, wherein said mirror housing has a home position, and
said mirror position controller controls said mirror mount motor to move said movable mirror and said light source to said home position when said mirror system is deactivated.

11. The mirror system of claim 1, wherein said mirror system is in communication with said tractor, such that:
when said tractor is in a reverse gear or a low range forward gear said mirror system is activated; and
when said tractor is in neutral or a high range forward gear, said mirror system is deactivated.

12. The mirror system of claim 1, wherein said convex mirror is movable.

13. The mirror system of claim 12, wherein said mirror housing further includes a baffle, and
wherein said mirror position controller moves said convex mirror, said planar mirror, said light source and said baffle via said mirror movement motor in response to said signal so as to track the movement of the rear corner of the trailer and to allow observation of the rear corner of the trailer by the driver while backing in lighted or unlighted conditions.

14. The mirror system of claim 1, wherein said mirror housing includes said deformable mirror in which a shape of said deformable mirror is changed by a mirror shape changing motor.

15. The mirror system of claim 7, wherein said transmitted signal is a radio frequency encrypted with a 16 to 128 bit encryption.

16. The mirror system of claim 1, wherein said mirror housing is attached to a door of said tractor.

17. The mirror system of claim 1, further comprising a positioner device located at a rear end of the trailer,
wherein said position device communicates with an antenna connected to said mirror position controller via a transmitted signal, which is a radio frequency encrypted signal, and a position of said at least one moveable mirror is automatically adjusted by said mirror position controller via said mirror movement motor in response to said transmitted signal to track movement of the rear corner of the trailer, and
wherein said positioner device contains at least one illumination light source to illuminate the rear corner of the trailer to allow continuous observation of the rear corner of the trailer by a driver in either lighted or unlighted conditions.

18. The mirror system of claim 17, wherein said positioner device is removably attached to the trailer.

19. The mirror system of claim 17, wherein said positioner device is powered by the tractor.

20. The mirror system of claim 1, wherein said mirror movement motor moves the mirror housing so as to change the position of all of said mirrors, and
wherein the mirror movement controller automatically returns to a home position a predetermined time period after the mirror position controller causes said mirror movement motor to move said housing and is then deactivated.

21. The mirror system of claim 1, wherein the mirror housing includes only one said deformable mirror.

22. The mirror system of claim 21, wherein the mirror housing is attached to the door of the tractor.

23. The mirror system of claim 14, wherein said mirror movement motor and said mirror shape changing motor are powered by the tractor.

24. The mirror system of claim 23, further comprising a positioner device located at a rear end of the trailer,
wherein said positioner device communicates with an antenna and a receiver connected to said mirror positioning controller via a transmitted signal, which is a radio frequency encrypted signal, and wherein position and shape of said mirror are automatically adjusted by said mirror position controller via said mirror movement motor in response to said transmitted signal to track movement of the side rear corner of the trailer and to allow continuous observation of the rear corner of the trailer by a driver,
wherein said positioner device contains at least one illumination light source to illuminate the rear corner of the trailer.

25. The mirror system of claim 24, wherein said positioner device is removably attached to the trailer.

26. The mirror system of claim 24, wherein said positioner device is powered by a battery.

27. The mirror system of claim 24, wherein said positioner device is powered by the tractor.

28. The mirror system of claim 7, wherein said positioner device is powered by a battery.

29. The mirror system of claim 17, wherein said positioner device is powered by the battery.

30. The mirror system of claim 7, wherein said positioner device contains at least one illumination light source to illuminate the passenger side rear corner of the trailer.

31. The mirror system of claim 1, wherein said mirror housing is attached to a passenger side of the tractor.

32. The mirror system of claim 1, wherein said mirror housing is attached to a driver side of the tractor.
